(19) United States
(12) Patent Application Publication
(10) Pub. No.: US 2014/0175281 A1
(43) Pub. Date: Jun. 26, 2014

(54) MULITPLE CONTROLLED ELECTROCHROMIC DEVICES FOR VISIBLE AND IR MODULATION

(71) Applicants: John R. Reynolds, Dunwoody, GA (US); Ryan M. Walczak, Blacksburg, VA (US); Andrew Gabriel Rinzler, Newberry, FL (US); Svetlana V. Vasilyeva, Gainesville, FL (US); Aubrey Lynn Dyer, Atlanta, GA (US)

(72) Inventors: John R. Reynolds, Dunwoody, GA (US); Ryan M. Walczak, Blacksburg, VA (US); Andrew Gabriel Rinzler, Newberry, FL (US); Svetlana V. Vasilyeva, Gainesville, FL (US); Aubrey Lynn Dyer, Atlanta, GA (US)

(73) Assignee: University of Florida Research Foundation, Inc., Gainesville, FL (US)

(21) Appl. No.: 14/127,816

(22) PCT Filed: Jun. 28, 2012
(86) PCT No.: PCT/US2012/044569

§ 371 Date: Dec. 19, 2013

Related U.S. Application Data
(60) Provisional application No. 61/503,015, filed on Jun. 30, 2011.

(51) Int. Cl. G02F 1/163; G01J 1/44; G02F 1/157; G01J 1/04

(52) U.S. Cl. CPC G02F 1/163; G01J 1/0407; G01J 1/44; G02F 1/157; Y10S 977/742; B82Y 99/00
USPC 250/338.1; 250/216; 250/201.1; 359/275; 977/742

(57) ABSTRACT

An electrochromic device (ECD) includes an electrochromic cell and, optionally, one or more additional electrochromic cells where all cells are parallel, and where at least one of the electrodes of one of the cells comprises a single-walled carbon nanotube (SWNT) film The electrochromic cells allow the control of transmittance of two or more different portions of the electro-magnetic spectrum through the ECD. One cell can control the transmittance of visible radiation while the other cell can control the transmittance of IR radiation. The ECD can be employed as a “smart window” to control the heat and light transmission through the window. The ECD can be in the form of a laminate that can be added to an existing window.

### CROSS-REFERENCE TO RELATED APPLICATION

The present application claims the benefit of U.S. Provisional Application Ser. No. 61/503,015, filed Jun. 30, 2011, which is hereby incorporated by reference herein in its entirety, including any figures, tables, or drawings.

### BACKGROUND OF INVENTION

Annually, about four percent of the total U.S. energy consumption results from window inefficiencies due to poor insulation and high transmission of solar radiation that allows an undesired heat gain or loss in the building that increases cooling or heating costs. The removal or covering of windows requires an increase in costs for lighting and reduces the aesthetics and other benefits of natural light that have been demonstrated to increase a workforce's productivity and sense of well-being. Where blinds are used to avoid disruptive glare, frequently they are not reopened when the glare ceases.

To address these shortcomings, dynamic windows are at the forefront of energy efficient window research. Electrochromic windows that can controllably modulate visible light, and/or heat flux characteristics upon application of a controlled voltage are promising candidates to mitigate inefficiencies in windows, as the heat flux characteristics of the window can be manually or automatically controlled. However, no system has been demonstrated that independently and simultaneously varies the heat flow (near infrared (NIR) and/or middle infrared (MIR) transmittance) and the visible transparency of the window. While indium tin oxide (ITO) can be used as the transparent electrode(s) in dynamic windows, its inherent properties present many drawbacks for its use in flexible electrochromic devices (f-ECDs). For example, ITO on plastic cracks and becomes unusable when repeatedly bent, making it unsuitable for retrofitting existing windows. Furthermore, ITO reflects infrared (IR) light, and, therefore, does not permit IR transmittance at levels as high as might be desired.

In addition to smart window applications, absorptive/transmissive IR f-ECDs on suitable IR transparent conducting substrates could be used as bendable, lightweight IR shutters and filters for IR detectors and imaging systems. The IR technology area would greatly benefit from introducing f-ECDs as replacement of high-cost heavy mechanical counterparts.

### BRIEF SUMMARY

Embodiments of the subject invention relate to an ECD that simultaneously allows independent heat and light control by regulation of one or more electrochromic cells in the ECD. The electrochromic system, according to embodiments of the invention, comprises at least one electrochromic cell, where those ECDs having a plurality of cells include at least one electrode of at least one of the cells that comprises a single walled carbon nanotube (SWNT) comprising film.

Each of the cells includes a working electrode, an electrochromic layer, an electrolyte layer, and a charge balancing layer. In one embodiment, a single electrochromic cell uses an electrochromic material that changes its absorbance/transmittance or reflectance in the visible and/or infrared spectral regions, allowing the simultaneous control of visible and IR modulation or just infrared contrast. The ECD can be used as a “smart window” or as an IR shutter/filter in a detecting/imaging system. In another embodiment, one of a plurality of independent electrochromic cells uses an electrochromic material that changes its absorbance or reflectance in the visible, while a second cell uses an electrochromic material that changes its absorbance or reflectance in the infrared. Therefore, by independently controlling the potential applied to the electrochromic cells, heating radiation (IR) and visible light passage can be independently controlled when the system is employed as a “smart window.”

The ECD can further comprise temperature and/or light sensors for automatic control. In one embodiment, a light sensor is included in a circuit to the cell using a visible absorptive or reflecting electrochromic material and a temperature sensor is included in the circuit to the cell using an infrared absorbing or reflecting electrochromic material.

The ECD can be free-standing or it can be in the form of a laminate that can be applied to an existing surface. The ECD allows manual or automatic control of the light and heat (infrared) through the system.

### BRIEF DESCRIPTION OF DRAWINGS

FIG. 1 shows transmission spectra of: 150-nm thick free-standing SWNT films (top curve), the AM1.5G solar irradiation spectrum (λₘₐₓ=1.6485 W/m⁻² nm⁻¹), (right curve from ASTM G173-03 Reference Spectra), and emission from a blackbody radiator at 23.9° C. (λₘₐₓ29.8=W·m⁻²·μm⁻¹) calculated using Planck's equation (left curve) where top arrows denote common electromagnetic spectral regions, shaded areas denote portions of the spectrum where transparency of at least one electrode is desirable in an electrochromic device (ECD), according to embodiments of the invention.

FIG. 2 shows transmission spectra of 60 nm SWNT films on polyethylene (PE) (0.001 and 0.003 inches thick) displaying high (70-80%) transmission of the SWNT/PE in the MIR region.

FIG. 3 shows an electrochromic device (ECD) having two independent electrochromic cells where two SWNT comprising electrodes are deposited on two sides of a central common substrate, in accordance with an embodiment of the invention.

FIG. 4 shows the chemical structure of “Sticky-PF” that can be used with SWNT films in ECDs, according to embodiments of the invention.

FIG. 5 shows an ECD comprising a single cell where visible light and IR are simultaneously modulated in a single electrochromic cell with two SWNT comprising electrodes, in accordance with an embodiment of the invention.

FIG. 6 shows transmission spectra in the A) Vis/NIR region and B) MIR for a single cell ECD having a black-to-transmissive electrochromic polymer deposited on a SWNT cathode and a MCCP electrochromic polymer on a SWNT anode using two PE substrates in a visibly colored state and visibly bleached state, according to an embodiment of the invention.

### DETAILED DESCRIPTION OF THE EMBODIMENTS

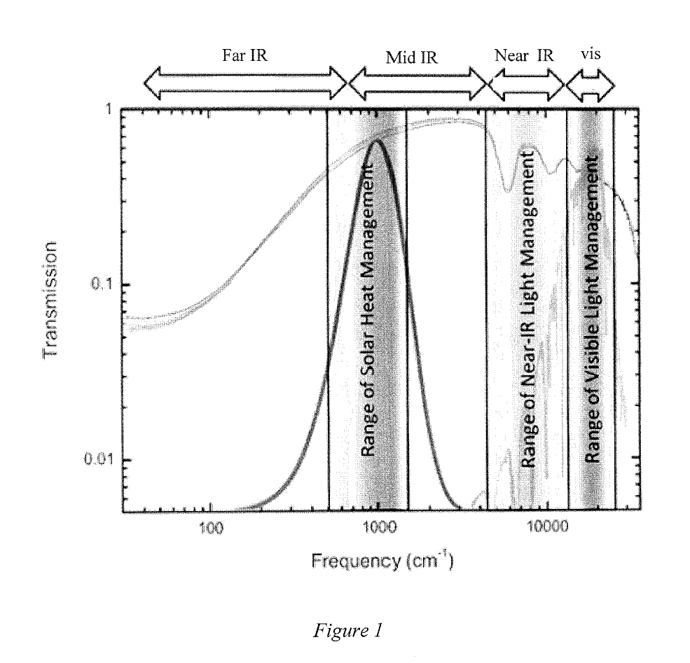

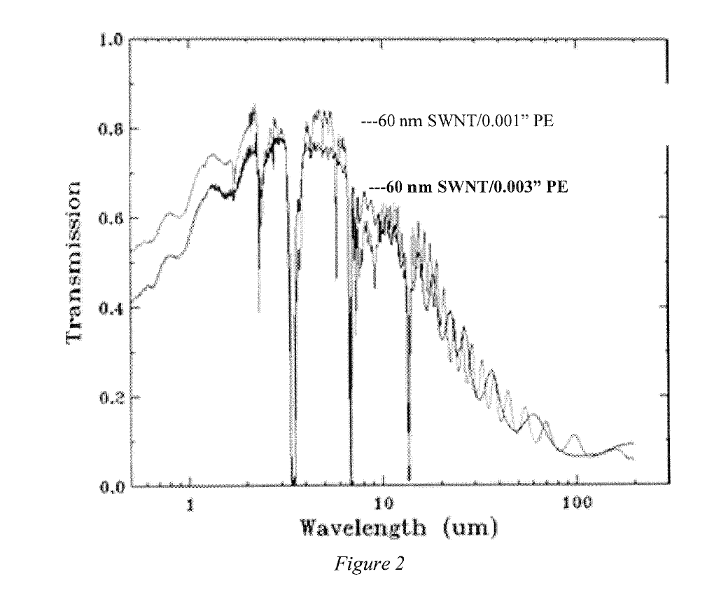

Embodiments of the invention are directed to electrochromic devices (ECDs) allowing control of IR absorbance or reflection independently of visible light or simultaneously with the visible modulation. The device can be free-standing or can be a laminate that can be attached to a surface of another device. For example, in one embodiment of the invention, the substrate upon which an ECD is deposited can be a glass or a plastic that constitutes the majority of the mass of an existing window. Single walled nanotube (SWNT) films have been developed for applications as transparent conductors, as disclosed in U.S. Pat. No. 7,261,852, which is incorporated herein by reference. FIG. 1 shows the transmittance spectrum of a free-standing 150 nm thick film of SWNTs ranging from the far IR to the UV. A majority of solar heating results from absorbed solar radiation in the 400 to 1250 cm⁻(8-25 micron) region as indicated in FIG. 1. A relatively thick SWNT film exhibits 50 to 80% transmittance in the mid-IR. SWNT films exhibit a high transmissivity in the IR region, which is a region where ITO is effectively opaque. A high concurrent transparency, from the visible to the far IR, makes SWNT films effective conductors for use as electrodes of an ECD that simultaneously controls IR heat flow and visible light. Another advantageous feature of SWNT films is robustness to repeated bending with no loss in properties. These features make SWNT films useful for flexible electrochromic devices (f-ECDs) that control the visible color density and heat generating radiation in “smart windows” applications or that control visible and IR contrast in a detecting/imaging system. IR spectra of SWNT films, on two different polyethylene (PE) sheet thicknesses, are shown in FIG. 2. These films display 70 to 80% transmittance in the mid-IR (MIR).

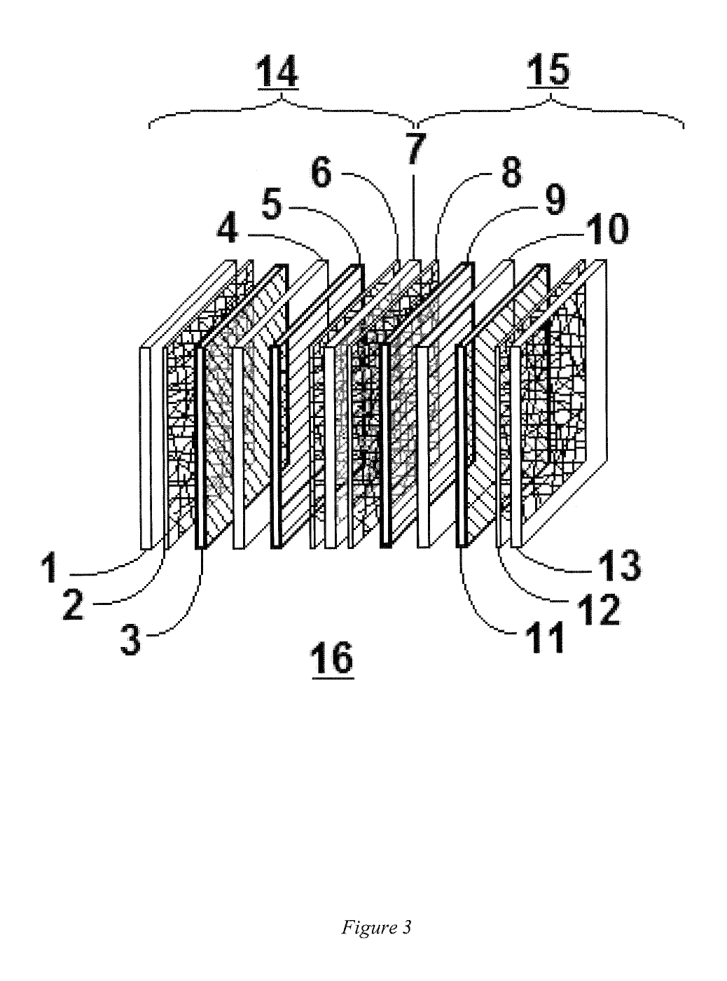

An ECD 16, according to an embodiment of the invention, comprises two independent cells in the form of a laminate, as shown in FIG. 3, in an expanded, delaminated, form. It should be understood that the ECD can include a substrate that functions as the window or other device to which the illustrated laminate is attached. In this exemplary embodiment, two cells that comprise the ECD share a common central substrate 7; however, those skilled in the art can readily appreciate that two separate substrates 7′ and 7″ can replace common substrate 7. A first cell 14 controls the visible light through the ECD, where a substrate 1 has a SWNT film 2 that acts as an electrode for the first cell. Optionally, SWNT film 2 can include a non-conjugated, partially conjugated, or fully conjugated polymer with pendent groups to provide a robust complexation with the SWNTs, as disclosed in PCT Patent Application Publications: WO/2008/046010; WO/2008/103703; or WO/2009/023337, which are incorporated herein by reference. The SWNT film 2 electrically contacts an electrochromic layer 3 that changes its absorbance of visible light as it is electrically switched between a neutral and an oxidized state. The electrochromic layer 3 is connected by an electrolyte layer 4 to a charge balancing polymer layer 5, which contacts a double-sided electrode that comprises SWNT films 6 and 8 coated on both sides of substrate 7, where SWNT film 6 is an electrode of the first cell 14 and SWNT film 8 is an electrode of the second cell 15. The second cell's 15 structure within the ECD 16 can mirror the first cell's 14 structure with the exception that the electrochromic layer 11 comprises an electrochromic polymer that absorbs or reflects infrared light in, for example, a neutral (or oxidized) state and transmits infrared light in, for example, an oxidized (or neutral) state. Contacting the SWNT film 8 is a second charging balancing layer 9, which contacts a second electrolyte layer 10 that separates the charge balancing layer from the second electrochromic material 11. The second cell 15 and device 16 are completed by an electrode of the second cell that comprises a SWNT film 12 coated substrate 13.

In embodiments of the invention, the substrates 1, 7, or 13 are transparent and can be, for example, a plastic such as polyethylene (PE), polypropylene (PP), poly(ethylene terephthalate) (PET), poly(ethylene naphthalates) (PEN), poly(phenylene sulfide) (PSS), polycarbonate (PC), a polysulfone, a polyethersulfone, poly(methylmethacrylate) (PMMA), or any other transparent or transparent UV-stabilized material. In another embodiment of the invention, the substrates 1, 7, or 13 are transparent and can be an elastomer, for example, polydimethylsiloxane (PDMS) or other silicone, polybutadiene, polyisoprene, or any copolymers thereof In other embodiments of the invention, the substrate 1, 7, or 13 can be a glass, semiconductor, or other materials of suitable transmissivity in the desired electrochromic wavelength region. In embodiments of the invention, where the device is a new or replacement window, the transparent substrate 1, 7, or 13 can be the major portion of the window. Where the transparent substrate is the exterior portion of the window, the use of a tough plastic, for example, PC or PET, can reduce the thermal conductivity and increase the impact resistance relative to that of similarly thick glass windows, which are commonly employed in existing structures.

The SWNT comprising films 2, 6, 8, and 12 can be fabricated on the substrates 1, 7, or 13, as taught in Rinzler et al., U.S. Pat. No. 7,261,852, which is incorporated herein by reference. Any other methods of depositing a transparent and conductive SWNT comprising film on the substrate can be employed. The SWNT comprising film can include metallic nanowires, graphene sheets, conducting polymers and/or other semiconducting or insulating materials in a controlled manner. The SWNTs can be undoped or doped. The SWNT dopant can be, for example, sulfuric acid, nitric acid, ammonia, or a halogen.

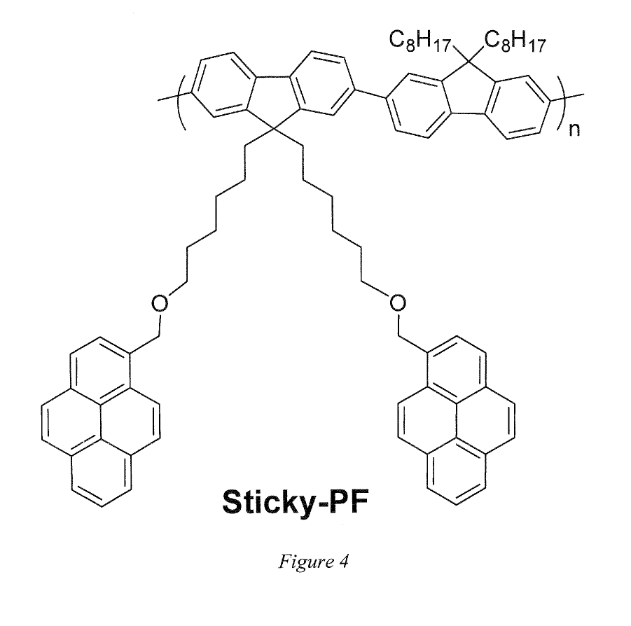

In some embodiments of the invention, so called “sticky foot” polymers, as described in PCT Patent Application publication WO/2008/046010, are included with one or more of the SWNT films 2, 6, 8, and 12 to promote incorporation of conjugated and/or electrically conducting polymers. Such “sticky foot” polymers promote attachment, as approximately a monolayer, to the surface of the SWNTs. Functionalized “sticky foot” polymers can have pendant substituents, for example, perfluoroalkyl chains, ethylene oxide chains, alkyl chains, siloxane chains or combinations thereof, to increase or decrease the hydrophobicity of the SWNT film's surface. FIG. 4 shows the structure of a “sticky foot” polymer “Sticky PF” that can be used for stabilizing the interfaces to a SWNT film, according to embodiments of the invention.

The charging balancing layers 5 and 9 do not change color, yet undergo electrochemical redox reactions that balance the cell's charge during switching. In addition to conjugated polymers, other electroactive materials can be used to balance the charge during switching. Polymers that can be used as the charging balancing layer 5 or 9 include redox polymers that have specific spatially and electrostatically isolated highly localized electrochemically active sites. A typical redox polymer consists of a system where a redox-active transition metal based pendant group is covalently bound to a polymer backbone. The polymer backbone can be conjugated or non-conjugated. Non-limiting examples of redox active polymers that can be employed in embodiments of the invention include: poly(vinyl ferrocene) and copolymers thereof; poly(vinyltripyridyl cobalt dichloride) and copolymers thereof; poly(4-vinylpyridyl osmium bis-bipyridyl dichloride) and copolymers thereof; poly(pyrrole-co-N-benzyl ruthenium bis-bipyridyl chloride); poly(N-2-cyanoethyl-3,4-propylenedioxypyrrole); and polymers bearing the redox-active 2,2,6,6-tetramethylpiperidin-N-oxyl group, such as poly(2,2,6,6-tetramethylpiperidinyloxy-4-yl methacrylate) and poly [2,3-bis(2,2,6,6-tetramethylpiperidine-N-oxycarbonyl)-norbornene].

The electrolyte layers 4 and 10 can be a gel electrolyte, a solid electrolyte, or an ionic liquid. In one embodiment of the invention, electrolyte layers 4 or 10 are gel electrolytes, such as an acetonitrile (ACN), propylene carbonate (PC), ethylene carbonate (EC), other alkylcarbonate, or mixed alkylcarbonates solutions containing poly(methyl methacrylate) and electrolyte salts, such as TBAPF₆ or ionic liquids (ILs). Electrolyte salts contain organic cations, including, but not limited to, tetraalkylammonium or alkali metal cations, including Li⁺, Na⁺, K⁺, and Cs⁺with non-nucleophilic anions, including, but not limited to, tetrafluoroborate, perchlorate, triflate, bis(trifluoromethylsulfonyl)imide, or hexafluoroantimonate. Examples of ILs include, but are not limited to: pyridinium chloride; 1-butyl-3-methylimidazolium 1-ethyl-3-methylimidazolium dicyanamide; bis(trifluoro-methylsulfonyl)imide; and 1-butyl-3,5-dimethyl-pyridinium bromide. In another embodiment of the invention, electrolyte layers 4 or 10 can be solid state electrolytes. Solid electrolytes include polar polymer hosts, such as: poly(ethylene oxide); poly(propylene oxide); methoxyethoxyethoxy substituted polyphosphazene; polyether based polyurethanes; and other polymers that are able to dissolve metal salts and give ionically conducting complexes. Room temperature conductivities of 10⁻⁵ to 10⁻³ S/cm are typically attained. Enhanced electrochromic switching speeds can be attained where higher ionic conductivities are reached with these electrolytes at elevated temperature.

In one embodiment of the invention, the electrochromic layer 3 changes absorbance in the visible region and the electrochromic layer 12 changes absorbance or reflectance in the infrared. In other embodiments, the electrochromic layer 3 and/or layer 12 changes transmissivity in other regions of the EM spectrum, including UV, visible, near IR, short IR, mid IR, far IR, and microwave, as designed for the specific application of the system. In another embodiment of the invention, the electrochromic layers 3 and/or 12 reflect visible or infrared light, respectively. In other embodiments of the invention, at least one of the electrochromic layers 3 and/or 12 comprises an inorganic semiconductor. Electrochromic polymers that can be used for the electrochromic layer 3, include those comprising PProDOT, PEDOT, Ppy, PANI, and polymers taught in U.S. Pat. Nos. 7,807,758 and 6,791,738, and International Application Publication Nos. WO/2011/003076, WO/2010/138566, WO2010/062948, WO/2009/058877, WO/2009/117025, and WO/2008/118704, where all of these patents and published patent applications are incorporated by reference herein.

Electrochromic materials that absorb or reflect in the IR and can be used, according to embodiments of the invention, for the electrochromic layer 12, include, but are not restricted to: ruthenium(II) dioxolene complexes, polymers, and copolymers derived therefrom; tris(pyrazolyl)borato-molybdenum complexes, polymers, and copolymers derived therefrom; substituted and unsubstituted N,N,N′,N′-tetraphenyl-p-phenylenediamines (TPPA), polymers, and copolymers derived therefrom; substituted anthraquinone imides, polymers, and copolymers derived therefrom; dicarbonylhydrazine containing dinuclear ruthenium complexes, polymers, and copolymers derived therefrom; and poly(N-alkylalkylenedioxypyrrole)s; and metal oxide semiconductors, for example nickel, and/or tungsten oxide comprising semiconductors.

In other embodiments of the invention, the ECD includes two independent electrochromic cells coupled by the double-sided SWNT electrode, where the configuration of the electrochromic, electrolyte, and charge balancing layers differs from the configuration of FIG. 3. For example, the relative position of the electrochromic layer 3, the charge balancing layer 5, and/or the electrochromic layer 12 and the charge balancing layer 9, can be reversed. In another embodiment of the invention, the ECD includes a multiplicity of electrochromic cells stacked with a plurality of double-sided electrodes, where each electrochromic cell is electrically isolated from other cells.

In another embodiment of the invention, the ECD includes at least one electrode comprising a SWNT film and the other electrode comprises a transparent conductor, such as a transparent conducting oxide (TCO), for example, indium-tin-oxide (ITO), MWNTs, DWNTs, graphene, and carbon nanohorns. Carbon comprising conductors can be doped or undoped. In another embodiment of the invention, the substrate is coated with a thin semi-transparent metalized layer, allowing partial reflection/partial transmittance of radiation. In yet another embodiment of the invention, the substrate is coated with a metalized layer, for example, a gold layer, to allow attenuated reflectance of radiation.

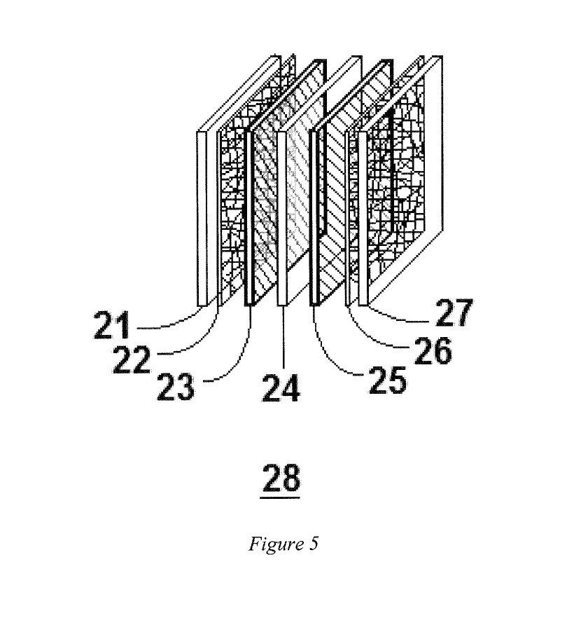

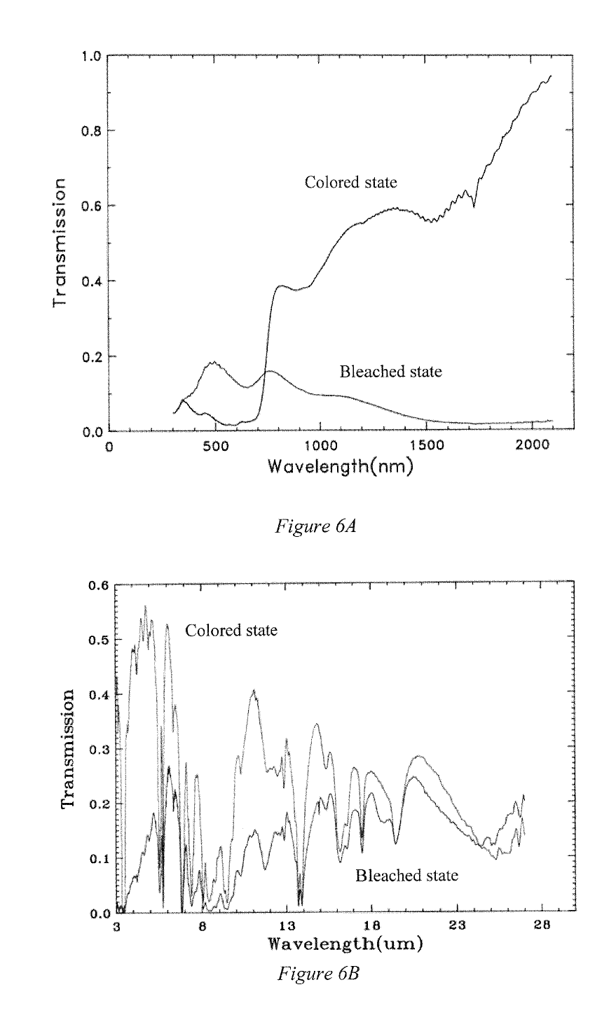

In another embodiment of the invention, the ECD comprises a single cell 28, as shown in FIG. 5, where the visible light and the IR are simultaneously modulated by the electrochromic layers 23 and 25, respectively, which are separated by an electrolyte layer 24. In this embodiment of the invention, two electrodes 22 and 26 can be SWNT films on substrates 21 and 27, for example, polyethylene sheets. When a negative voltage is applied, the ECD is absorptive in the visible region and displays color and has low absorbance in the NIR and MIR. When a positive voltage is applied, the ECD becomes highly transmissive in the visible but has a relatively high absorbance in the NIR and MIR. An exemplary cell has: a black-to-transmissive electrochromic donor-acceptor (DA) copolymer comprising the electron-donor 3,4-propylenedioxythiophene (ProDOT) and the electron-acceptor 2,1,3-benzothiadiazole (BTD) contacting a Sticky-PF coated 60 nm SWNT film cathode; a 0.001 inch polyethylene (PE) substrate coupled to a minimally coloring N-octadecyl substituted poly(3,4-propylenedioxypyrrole) on a Sticky-PF coated 60 nm SWNT film anode; and a gel electrolyte of 7.2% 1-ethyl-3-methylimidazolium bis(trifluoromethylsulfonyl)imide (EMI-BTI), 7.0% of PMMA, 48.1% PC, and 37.7% Ec (wt %) with 2 mg of PE beads (70 μm) per 12 mL solvent, which separates the two electrochromic polymers. Visible, NIR and mid-IR spectra for this ECD are shown in FIG. 6.

Another embodiment of the invention is directed to a window comprising at least one ECD laminate on at least one surface of the window. In another embodiment of the invention, a window fixture comprises at least one ECD laminate positioned essentially parallel to at least one surface of the window, where an enclosed volume exists between the electrochromic laminate and the window. In one embodiment, the volume between the ECD laminate and the window is filled with a gas, generally a dry gas, for example, dry air or an inert gas, such as nitrogen or argon, or is evacuated to form a vacuum between the window and the laminate.

In an embodiment of the invention, a window comprises the ECD, where the window is a transparent substrate of the ECD. In this embodiment of the invention, the ECD can be a flat plate, or can display curvature having any other shape, for example, a dome. Windows, according to this embodiment of the invention, can be used for structures that are not buildings, for example, face shields, wind shields for automobiles and other vehicles, or any other applications where the shape is preferentially not a flat plate but where independent control of the transmittance of visible and IR radiation is advantageous.

In an embodiment of the invention, the ECD can include one or more light sensors. The light sensors can detect any desired wavelengths or range of wavelengths on one or both faces of the ECD. The sensor can detect one or more wavelengths or a range of wavelengths in the visible and/or infrared portion of the electromagnetic spectrum. For example, two sensors can be included that independently detect the quantity of visible and IR light on one side of the ECD, such that the applied potential difference across the electrodes of one or both electrochromic cells of the ECD can be diminished or increased to change the visible or IR radiation transparency of the ECD in a desired manner based on the intensity of the radiation measured by the sensors. In another embodiment of the invention, one or more temperature sensors can be included on one or both faces of the ECD, such that the measured temperature can be used to trigger change of the applied potential difference across the electrodes of one or more electrochromic cells of the ECD. Other sensors, for example motion detectors, can be interfaced with the ECD. The signals from light and/or temperature sensors can be input to a microprocessor or other programmable device to permit the adjustment of the potential difference across the electrochromic cells of the ECD in a predetermined manner. The light and/or temperature sensors can be integral with the ECD or can be remote to the surfaces of the ECD. In this manner, the ECD can behave as a “smart window” that promotes solar heating in a structure when the exterior temperature is below a desired temperature, discourages solar heating when the exterior temperature is above a desired temperature, and independently allows a desired, often maximal, amount of sunlight to penetrate the window.

In another embodiment of the invention, the ECD comprises a single cell, similar to that shown in FIG. 5. The cell contains only one electrochromic layer responsible for visible and IR absorbance/transmittance modulation, gel electrolyte, and two visible/IR transparent electrodes, for example, SWNT films or graphene sheets on flexible substrates. The counter electrode can contain a thicker conducting layer to effectively compensate the charge on the working electrode with an electrochromic layer. For example, when a negative voltage is applied, the ECD is absorptive in the visible region, displaying a color, while having low absorbance in the NIR, MIR and far IR, but when a positive voltage is applied, the ECD becomes highly transmissive in the visible, while having a relatively high absorbance in the NIR, MIR and far IR, as required for efficient IR shutters/filters for detecting and imaging system applications.

All patents and patent applications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. An electrochromic device (ECD), comprising a first electrochromic cell and, optionally, one or more additional electrochromic cells wherein all cells are parallel to and are electrically separated from each other, wherein each of the cells is independently controlled and at least one of the cells comprises an electrode comprising a single-walled carbon nanotube (SWNT) film, and wherein the first cell comprises a first electrochromic layer that changes in transmittance of radiation from a first portion of the electromagnetic spectrum and the additional cells comprise additional electrochromic layers that individually change in transmittance of radiation from additional portions of the electromagnetic spectrum.

2. The ECD of claim 1, wherein each of the electrochromic cells further comprises a charge balancing layer separated from the electrochromic layer by an electrolyte layer, disposed between an electrode on a substrate and a counter electrode on a second substrate.

3. The ECD of claim 2, wherein the electrode or the counter electrode of the first electrochromic cell shares a common substrate with the electrode or the counter electrode of one of the additional electrochromic cells.

4. The ECD of claim 1, wherein the first electrochromic layer comprises a first electrochromic material that changes transmittance in the visible and the additional electrochromic layer comprises an additional electrochromic material that changes transmittance in the infrared.

5. The ECD of claim 1, wherein the first electrochromic layer comprises a first electrochromic polymer.

6. The ECD of claim 5, wherein the first electrochromic polymer comprises a heterocyclic conjugated polymer.

7. The ECD of claim 4, wherein the additional electrochromic material comprises a semiconducting metal oxide.

8. The ECD of claim 7, wherein the semiconducting metal oxide comprises tungsten oxide or nickel oxide.

9. The ECD of claim 4, wherein the additional electrochromic material comprises an additional electrochromic polymer.

10. The ECD of claim 9, wherein the additional electrochromic polymer comprises a polymer or copolymer comprising a ruthenium(II) dioxolene complex, a polymer or copolymer comprising a tris(pyrazolyl)borato-molybdenum complex, a polymer or copolymer comprising a N,N,N′,N′-tetraphenyl-p-phenylenediamine, a polymer or copolymer comprising an anthraquinone imide, a polymer or copolymer comprising a dicarbonylhydrazine containing dinuclear ruthenium complex, a polymer or copolymer comprising a nitroxide radical, or poly(2,2,6,6-tetramethylpiperidinyloxy methacrylate) (PTMA).

11. The ECD of claim 1, wherein at least one substrate comprises a metalized layer allowing partial reflection or attenuation of radiation.

12. The ECD of claim 1, wherein all substrates independently comprise a polymer.

13. The ECD of claim 12, wherein the polymers independently comprise polyethylene (PE), polypropylene (PP), poly(ethylene terephthalate) (PET), poly(ethylene naphthalates) (PEN)), poly(phenylene sulfide) (PPS), polycarbonate (PC), a polysulfone, a polyethersulfone, poly(methylmethacrylate) (PMMA), polyisoprene, polybutadiene, and/or a silicone.

14. The ECD of claim 1, wherein at least one of the substrates is rigid.

15. The ECD of claim 1, wherein all of the substrates and the electrodes are flexible.

16. The ECD of claim 1, further comprising a volume filled with a gas separating the first and the additional electrochromic cells.

17. The ECD of claim 1, further comprising at least one light sensor and/or at least one temperature sensor.

18. The ECD of claim 17, wherein the light sensor senses IR radiation.

19. The ECD of claim 17, wherein the light sensor senses visible radiation.

20. The ECD of claim 17, further comprising a microprocessor to input a signal from the light sensors and/or temperature sensors and output a signal to adjust the potential applied to the one or more of the first and additional electrochromic cells.
